(19) United States
(12) Patent Application Publication
(10) Pub. No.: US 2009/0193938 A1
(43) Pub. Date: Aug. 6, 2009

(54) Fastener Guiding Tool

(76) Inventor: Marie G. Mentor, Hamden, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/026,833

(22) Filed: Feb. 6, 2008

(51) Int. Cl. B25C 3/00

(52) U.S. Cl. 81/44

(57) ABSTRACT

A fastener guiding tool includes a head containing a plurality of indentations of different dimensions for receiving fasteners. Optionally, a magnetic inset element is disposed within each of the indentations. The head may additionally include a level and measure marks.

### BACKGROUND

1. Field

Disclosed herein a tool effective to receive a fastener and is particularly concerned with a safe and cost effective magnetic fastener guiding tool that holds and guides fasteners.

2. Description of the Related Art

The use of a nail guiding device to receive and guide a nail into a work surface has been provided in the prior art. For example, U.S. Pat. No. 4,079,764 illustrates a nail spacing tool having a handle and a gripping body with a plurality of nail receiving openings for frictionally engaging the shanks of nails. This tool is non-magnetic.

U.S. Pat. No. 5,671,641 shows a nail guiding tool having a flexible polymer foam body with one or more slits to guide and position the nails. This tool is not magnetic.

U.S. Pat. No. 4,037,632 shows a nail holding device comprising a magnetic block having two sides meeting at a right angle. A longitudinally extending groove is provided on one side of the magnetic block to guide a nail and ensure that the nail is driven straight into a working surface.

U.S. Pat. No. 4,926,718 illustrates a nail holding tool including a sheath adapted to fit over a user's thumb and a nail holding fixture supported by the sheath.

U.S. Pat. No. 2,491,860 shows a nail holding device adapted to be fitted over the index finger of a carpenter's hand. The device has a magnetic end adapted to attract and hold nails in their driving positions during the driving of the nails.

U.S. Pat. No. 5,933,894 illustrates a combination tool including differently sized nail starting, though holes. This tool is non-magnetic.

As such, it may be appreciated that there continues to be a need for a simple, safe, convenient and cost effective fastener guiding tool.

### BRIEF SUMMARY

Disclosed herein is a tool effective to receive and hold a fastener. The fastener guiding tool includes a head containing a plurality of indentations of different dimensions. Optionally, a magnetic inset element is disposed within each of the indentations. The head may additionally include a level and measurement marks. The fastener guiding tool may be made of a compliant plastic material and may be substantially Z shaped.

The disclosed faster guiding tool can be used by either a right or left handed person. And it can be used in hard to reach corners either in a vertical, horizontal or oblique position. It is safe to use and cost effective. The tool and its features and advantages will now be described in more detail with reference to the drawings.

### BRIEF DESCRIPTION OF THE DRAWINGS

FIG. 1 is a schematic view of a fastener guiding tool according to one embodiment of the invention;

FIG. 2 is a cross-sectional view of the fastener guiding tool in FIG. 1;

FIG. 3 is a top view of the fastener guiding tool illustrated in FIG. 1.

### DETAILED DESCRIPTION

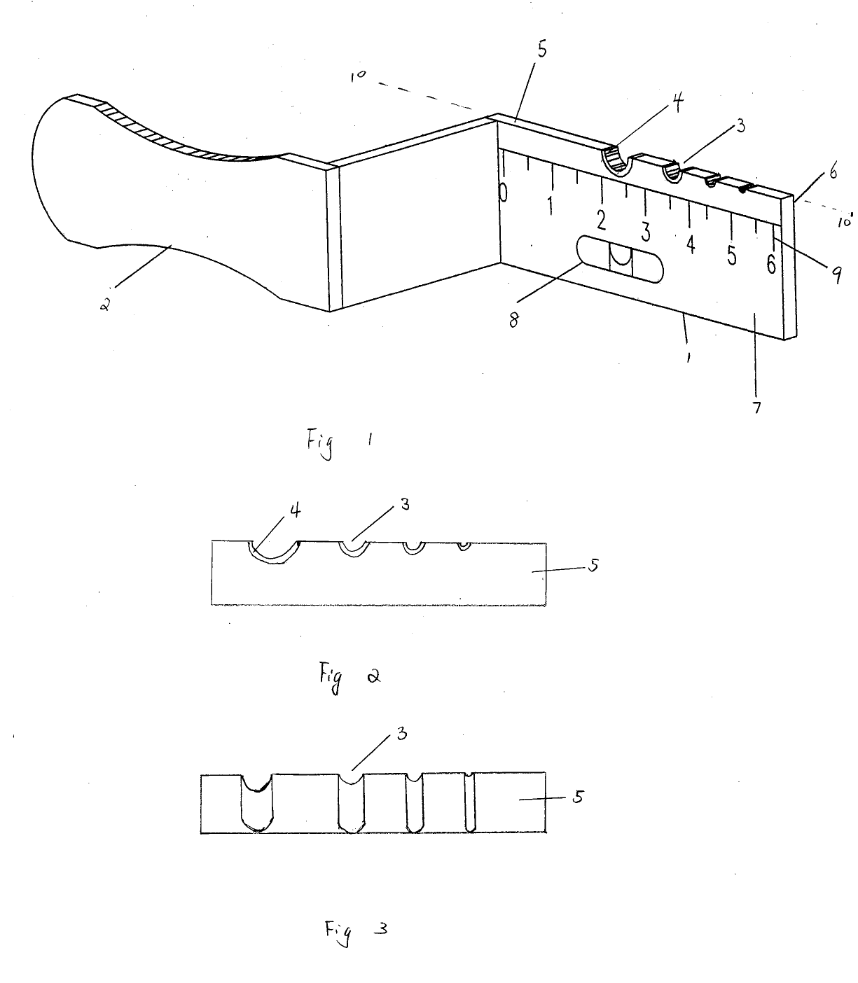

Referring to the drawings, and initially to FIG. 1, a fastener guiding tool includes a head (1) at a first end of the tool and a handle (2) at the second end of the tool. The head (1) has a first surface (5), a second surface (6) perpendicular to the first surface (5) and a third surface (7) opposite the second surface (6). The first surface (5) contains a plurality of indentions (3) of different dimensions for receiving a fastener. The fastener is formed from a magnetic material or includes a magnet portion. The magnetic material could be permanent (or hard) or temporary (or soft). The fastener may be a nail, tack, staple, screw or the like.

The indentations (3) normally extend perpendicularly from the second surface (6) to the third surface (7). This ensures that the fastener will be perpendicular to a working surface when the tool, often the second surface (6), is placed against the working surface.

The indentations (3) are not limited to any particular shapes. They could be V shaped or any other convenient shapes. In a preferred embodiment, the indentations (3) are arcuate. The arcuate indentions (3) are of different diameters and the exemplary diameters of the semi-circles are 0.06, 0.08, 0.10 and 0.14 inches. It is appreciated that the indentions (3) could be of any other sizes effective to hold commercially available fasteners.

In a preferred embodiment, a magnetic inset element (4) formed from a permanent (or hard) magnetic material is disposed within each of the plurality of indentations (3). Such magnetic insets (4) help to hold the fastener in place when the user tries to drive the fastener into a working surface. The magnetic inset (4) could be mounted in the indentations (3) by any conventional means such as gluing.

In another preferred embodiment, the head (1) includes a level (8) on the third face (7). The level (8) may be a bubble level, and it helps the user to place a plurality of fasteners in a horizontal or vertical line.

In yet another preferred embodiment, the head (1) further includes measurement marks (9) on the third surface (7). The total length of the scale is not limited to any size, but preferably 6 inches. The measurement marks help the users to space the fasteners in particular ways.

Preferably, the fastener driving tool is made of a compliant plastic material. The compliant material could be any polymeric materials that are relatively flexible. The advantage of such a tool is that when a user accidentally hit the tool with a hammer, it does not break. A fastener guiding tool made of soft plastic is also light and easy to carry around.

The shape of the fastener driving tool is essentially Z shaped. This allows users conveniently access the hard to reach corners. And the tool is friendly to both left hand and right hand users. In this embodiment, the handle (2) is parallel to the head (1) and extend to the opposite direction of the head (1), therefore a user could not accidentally hit his/her fingers with a misdirected blow of a hammer.

FIG. 2 illustrates a cross-sectional view of the head (1) in FIG. 1 along 10-10′ axis. FIG. 3 provides a top view of the fastener guiding tool shown in FIG. 1.

When the fastener driving tool is in use, a user can simply grasp the handle (2), press the second surface (6) of the head (1) against a work surface, hold a fastener in one of the plurality of indentations (3) and drive the fastener into the working surface by utilizing a hammer, a screw driver or any other convenient means. If desirable, the user may place a plurality of fasteners in a straight horizontal or vertical line by utilizing the level (8). In addition, the user may space the fasteners in particular ways by utilizing measurement marks (9).

It is within the embodiment of the invention to have a magnetic pad disposed on the first surface and within each of the indentions.

What is claimed is:

1. A tool effective to receive a fastener, comprising:
a handle at a first end of said tool; and
a head at an opposing second end of said tool, said head having a first surface containing a plurality of indentations of different dimensions.

2. The tool of claim 1, wherein said head further includes a second surface perpendicular to said first surface for overlaying a work surface and a third surface opposite said second surface.

3. The tool of claim 2, wherein a magnetic inset element is disposed within each of said plurality of indentations.

4. The tool of claim 3, wherein said indentations extend perpendicularly from said second surface to said third surface of said head.

5. The tool of claim 4, wherein said indentations are arcuate.

6. The tool of claim 2, wherein said head includes a level on said third surface.

7. The tool of claim 6, wherein a magnetic inset element is disposed within each of said plurality of indentations.

8. The tool of claim 7, wherein said indentations on said first surface of said head extend perpendicularly from said second surface to said third surface.

9. The tool of claim 8, wherein said indentations are arcuate.

10. The tool of claim 2, wherein said head includes measurement marks on said third surface.

11. The tool of claim 10, wherein said head further includes a level on said third surface.

12. The tool of claim 11, wherein a magnetic inset element is disposed within each of said plurality of indentations.

13. The tool of claim 12, wherein said indentations on said first surface of said head extend perpendicularly from said second surface to said third surface.

14. The tool of claim 13, wherein said indentations are arcuate.

15. The tool of claim 1, wherein said fastener is a nail.

16. The tool of claim 1, wherein said fastener is a screw.

17. The tool of claim 1 is made of a compliant plastic.

18. The tool of claim 1, wherein said tool is substantially Z shaped.
